(19) United States
(12) Patent Application Publication
(10) Pub. No.: US 2010/0066189 A1
(43) Pub. Date: Mar. 18, 2010

(54) Rotor for Motor

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/246,536

(22) Filed: Oct. 7, 2008

(30) Foreign Application Priority Data
Sep. 16, 2008 (TW) 97135497

(51) Int. Cl. H02K 21/14

(52) U.S. Cl. 310/156.09

(57) ABSTRACT

A rotor for a motor includes a shaft having an outer periphery with a positioning portion. The positioning portion has non-circular cross sections perpendicular to a longitudinal axis of the shaft. A plastic magnet is formed on the outer periphery of the shaft by injection molding. The plastic magnet includes an inner periphery engaged with the positioning portion. Thus, the plastic magnet is prevented from disengaging from the shaft and from rotating relative to the shaft. As a result, the rotor has enhanced engaging effect between the shaft and the plastic magnet. Furthermore, the rotor has a simple structure to allow easy assembly.

### BACKGROUND OF THE INVENTION

1. Field of the Invention

The present invention relates to a rotor for a motor and, more particularly, to a rotor for an inner rotor type motor.

2. Description of the Related Art

Motors currently available from the market include outer-rotor type and inner-rotor type. Since motors of inner-rotor type are more stable than outer-rotor type during rotation, the inner-rotor type motors can fulfill the heat dissipating needs in electronic products having developing trends in high speed, functional integrity, and miniaturization.

FIG. 1 shows a conventional rotor 7 for an inner rotor type motor. The rotor 7 includes a shaft 71 and a magnet 72. The magnet 72 includes an axial hole 721 through which the shaft 71 is extended and engaged. In an approach, the shaft 71 is engaged with the magnet 72 by tight coupling. However, the magnet 72 is liable to break. In another approach, the shaft 71 is engaged with the inner periphery of the axial hole 721 by an adhesive. However, the adhesive is liable to lose its adhesion due to deterioration, resulting in disengagement of the magnet 72 from the shaft 71 or undesired rotation of the magnet 72 relative to the shaft 71.

To solve the problems of the above conventional rotor 7, a design has been proposed and disclosed in U.S. patent application Ser. No. 12/078,070 entitled “MOTOR ROTOR STRUCTURE.” As shown in FIG. 2, the rotor 8 of this design includes a shaft 81, a plurality of retaining plates 82, at least two magnets 83, and two washers 84. The retaining plates 82 are stacked around the outer periphery of the shaft 81 and include at least two retaining grooves 821 receiving the magnets 83. The washers 84 hold the retaining plates 82 and the magnets 83 in place. Thus, disengagement of the magnets 83 from the shaft 81 is avoided by the arrangement of the retaining plates 82 and the washers 84. However, the rotor 8 has a complicated structure and, thus, fails to provide assembling convenience.

To solve the problems of the rotor 8, another design has been developed and disclosed in U.S. patent application Ser. No. 12/145,603 entitled “ROTOR STRUCTURE FOR MOTOR.” As shown in FIG. 3, the rotor 9 of such a design includes a shaft 91, a magnet 92, and two fixing seats 93. The magnet 92 includes an axial hole 921 through which the shaft 91 extends. The fixing seats 93 are in tight coupling with the shaft 91 and sandwich and retain the magnet 92 on the shaft 91 in a predetermined position. Thus, the magnet 92 is prevented from disengaging from the shaft 91 by the fixing seats 93. Although the rotor 9 is simpler than the rotor 8 in structure, two fixing seats 93 are still required to fix the magnet 92 in place. Conclusively, the rotors 8 and 9 are still too complicated and, thus, not easy to assemble, while the rotor 7 is simple but has insecure engagement between the magnet 72 and the shaft 71. Thus, a need still exists in improvement to the rotors 7, 8 and 9.

### SUMMARY OF THE INVENTION

The primary objective of the present invention is to provide a rotor for a motor that includes a shaft and a plastic magnet securely engaged on the shaft wile having a simple structure.

A rotor for a motor according to the preferred teachings of the present invention includes a shaft having an outer periphery with a positioning portion. The positioning portion has non-circular cross sections perpendicular to a longitudinal axis of the shaft. A plastic magnet is formed on the outer periphery of the shaft by injection molding. The plastic magnet includes an inner periphery engaged with the positioning portion. Thus, the plastic magnet is prevented from disengaging from the shaft and from rotating relative to the shaft. As a result, the rotor has enhanced engaging effect between the shaft and the plastic magnet. Furthermore, the rotor has a simple structure to allow easy assembly.

In a most preferred form, the positioning portion of the outer periphery of the shaft includes a plurality of grooves each extending in a direction parallel to and spaced from the longitudinal axis of the shaft. In another most preferred form, the positioning portion of the outer periphery of the shaft includes a rugged surface. In a further most preferred form, the positioning portion of the outer periphery of the shaft includes at least one recess having a flat bottom face, with the flat bottom face having a spacing to the longitudinal axis smaller than the outer periphery of the shaft.

In a most preferred form, the plastic magnet includes a plastic ring mounted around the outer periphery of the shaft. The plastic ring includes an inner periphery engaged with the positioning portion. An outer periphery of the plastic ring includes a coupling section having non-circular cross sections perpendicular to the longitudinal axis of the shaft. The plastic magnet further includes a plastic magnet ring mounted around the plastic ring, with an inner periphery of the plastic magnet engaged with the coupling section.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a cross sectional view of a conventional rotor for an inner rotor type motor.

FIG. 2 shows a cross sectional view of another conventional rotor for an inner rotor type motor.

FIG. 3 shows a cross sectional view of a further conventional rotor for an inner rotor type motor.

FIG. 4 shows a cross sectional view of a rotor for a motor of a first embodiment according to the preferred teachings of the present invention.

FIG. 5 shows a perspective view of a shaft of the rotor of FIG. 4.

FIG. 6 shows a cross sectional view of the shaft of FIG. 5.

FIG. 7 shows a cross sectional view of a rotor for a motor of a second embodiment according to the preferred teachings of the present invention.

FIG. 8 shows a perspective view of a shaft of the rotor of FIG. 7.

FIG. 9 shows a cross sectional view of a rotor for a motor of a third embodiment according to the preferred teachings of the present invention.

FIG. 10 shows a perspective view of the rotor of FIG. 9.

FIG. 11 shows a cross sectional view of a rotor for a motor of a fourth embodiment according to the preferred teachings of the present invention.

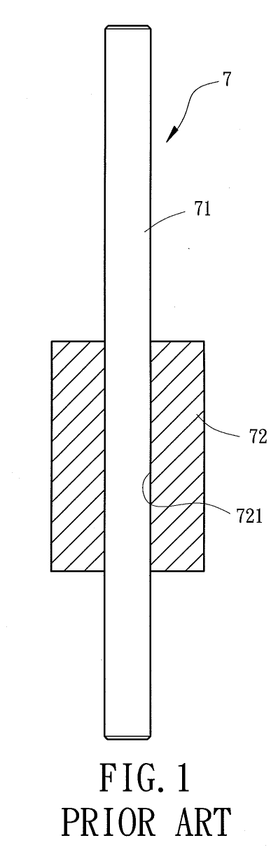

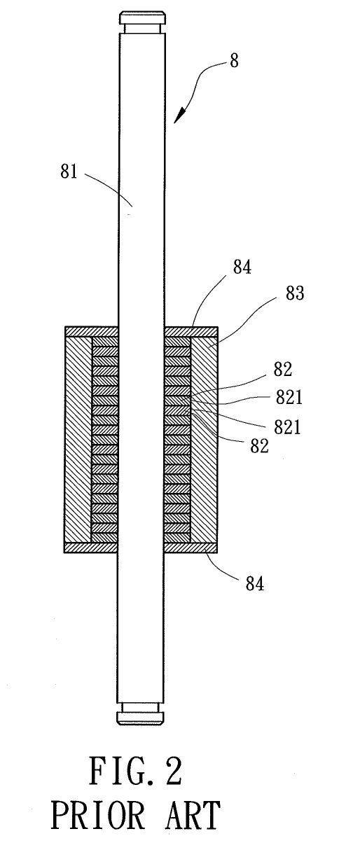

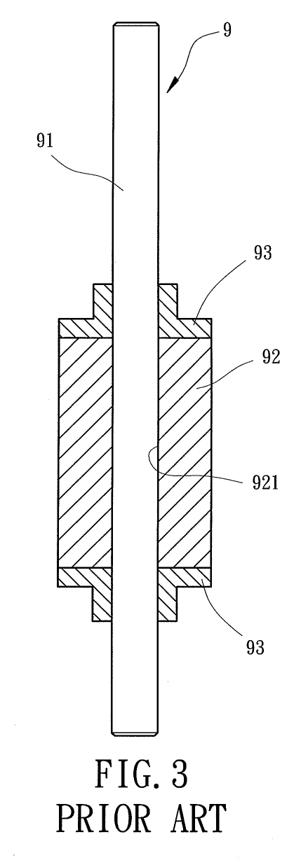

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “inner”, “outer”, “portion”, “section”, “longitudinal”, “axial”, “radial”, “circumferential”, “spacing”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

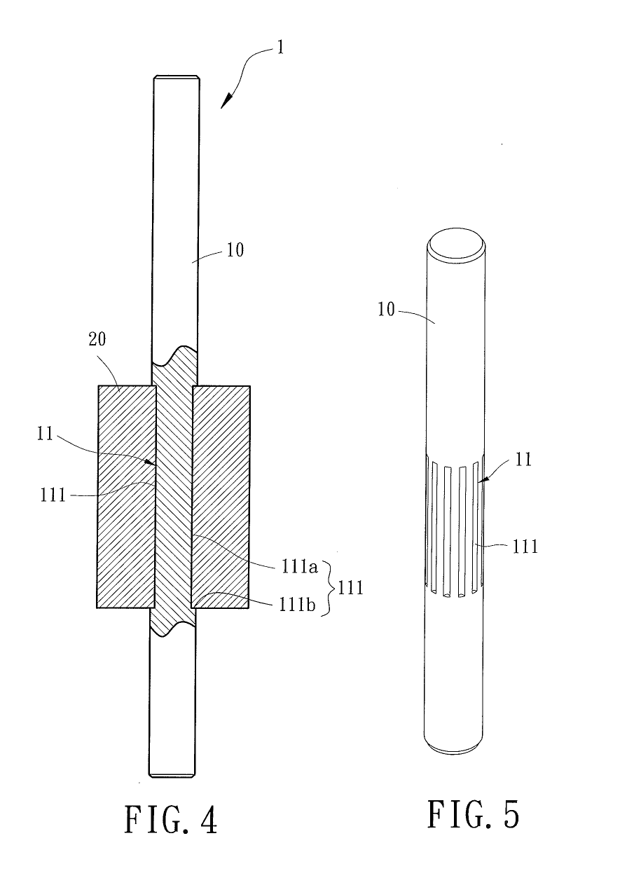

With reference to FIGS. 4 and 5, a rotor for motor according to the preferred teachings of the present invention includes a shaft 10 and a plastic magnet 20. The shaft 10 includes a positioning portion 11 to which the plastic magnet 20 is engaged. The positioning portion 11 has non-circular cross sections perpendicular to a longitudinal axis of the shaft 10. The outer periphery of the shaft 10 can include protruded portions (such as ribs or protrusions), recessed portions (such as grooves, recesses, or dimples), or rugged faces (such as embossments), so that the cross-sections of the positioning portion 1 are non-circular and located on a radial plane perpendicular to the longitudinal axis. The plastic magnet 20 is preferably made of a combination of plastic material and magnetic powders. The plastic magnet 20 is formed on the outer periphery of the shaft 10 by injection molding to enhance assembling convenience. Furthermore, the plastic magnet 20 is engaged with the positioning portion 11 to prevent the plastic magnet 20 from disengaging from the shaft 10 and from rotating relative to the shaft 10. Furthermore, a rotor having a simple structure is provided.

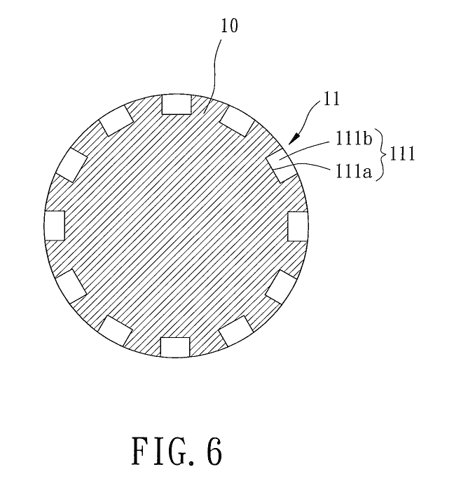

FIGS. 4, 5 and 6 show a rotor 1 for a motor of a first embodiment according to the preferred teachings of the present invention. According to the preferred form shown, the rotor 1 includes a shaft 10 and a plastic magnet 20. The shaft 10 includes a positioning portion 11 on an outer periphery thereof. The positioning portion 11 includes a plurality of grooves 111 each extending in a direction parallel to and spaced from the longitudinal axis of the shaft 10. Furthermore, the grooves 111 are spaced from one another in a circumferential direction. By providing the longitudinally extending grooves 111, the positioning portion 11 has non-circular cross sections perpendicular to the longitudinal axis of the shaft 10. The plastic magnet 20 is formed on the outer periphery of the shaft 10 by injection molding, with the inner periphery of the plastic magnet 20 engaged with the groves 111 of the positioning portion 11. Thus, the plastic magnet 20 is prevented from rotating relative to the shaft 10 and from disengaging from the shaft 10.

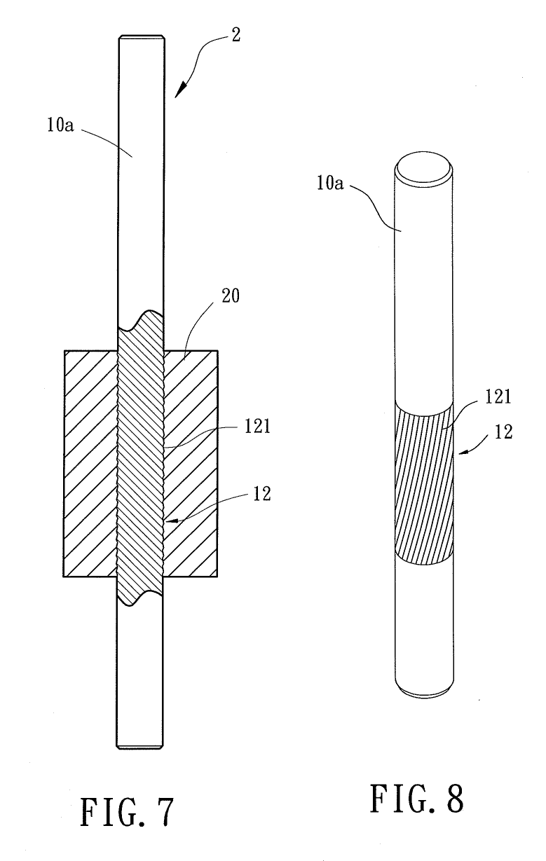

FIGS. 7 and 8 show a rotor 2 for a motor of a second embodiment according to the preferred teachings of the present invention. According to the preferred form shown, the rotor 2 includes a shaft 10a and a plastic magnet 20. The shaft 10a includes a positioning portion 12 on an outer periphery thereof. The positioning portion 12 includes a rugged surface 121 on the outer periphery of the shaft 10a. By providing the rugged surface 121, the positioning portion 12 has non-circular cross sections perpendicular to the longitudinal axis of the shaft 10a. The plastic magnet 20 is formed on the outer periphery of the shaft 10a by injection molding, with the inner periphery of the plastic magnet 20 engaged with the rugged surface 121 of the positioning portion 12. Thus, the plastic magnet 20 is prevented from rotating relative to the shaft 10a and from disengaging from the shaft 10a.

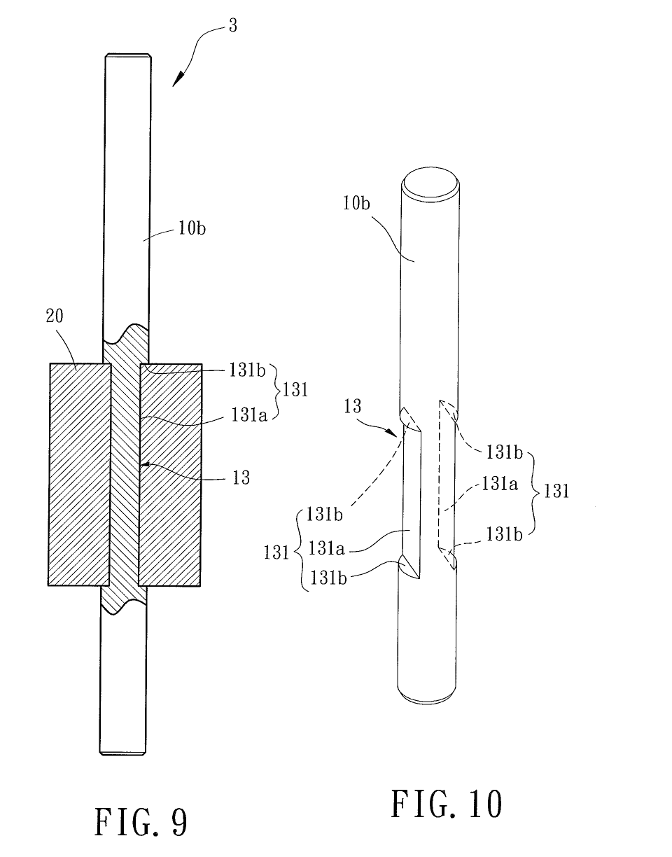

FIGS. 9 and 10 show a rotor 3 for a motor of a third embodiment according to the preferred teachings of the present invention. According to the preferred form shown, the rotor 3 includes a shaft 10b and a plastic magnet 20. The shaft 10b includes a positioning portion 13 on an outer periphery thereof. The positioning portion 13 includes two recesses 131 each including a flat bottom face having a spacing to the longitudinal axis smaller than the outer periphery of the shaft 10b. By providing the recesses 131, the positioning portion 13 has non-circular cross sections perpendicular to the longitudinal axis of the shaft 10b. The plastic magnet 20 is formed on the outer periphery of the shaft 10b by injection molding, with the inner periphery of the plastic magnet 20 engaged with the recesses 131 of the positioning portion 13. Thus, the plastic magnet 20 is prevented from rotating relative to the shaft 10b and from disengaging from the shaft 10b. It can be appreciated that the positioning portion 13 can also include only one recess 131 or more than two recesses 131.

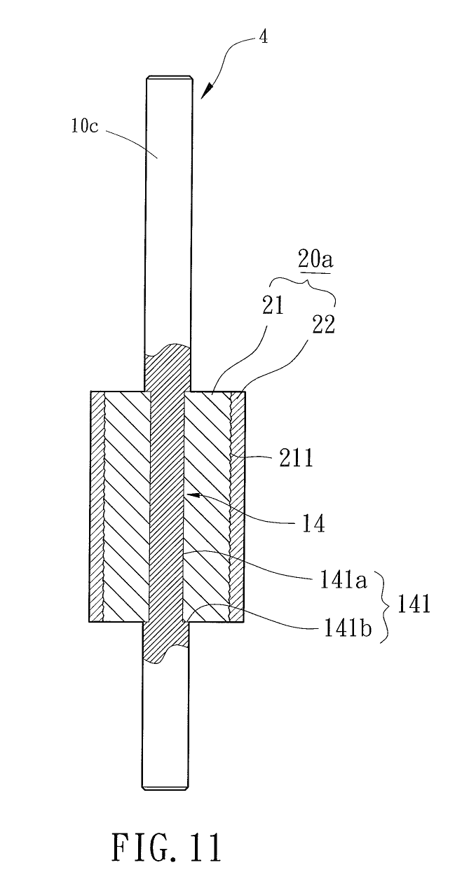

FIG. 11 shows a rotor 4 for a motor of a fourth embodiment according to the preferred teachings of the present invention. According to the preferred form shown, the rotor 4 includes a shaft 10c and a plastic magnet 20a. The shaft 10c includes a positioning portion 14 on an outer periphery thereof. The positioning portion 14 has non-circular cross sections perpendicular to the longitudinal axis of the shaft 10c by providing one of the above arrangements. The plastic magnet 20a includes a plastic ring 21 and a plastic magnet ring 22. The plastic ring 21 is made of plastic material and formed on the outer periphery of the shaft 10c by injection molding, with the inner periphery of the plastic ring 21 engaged with the positioning portion 14. Furthermore, the outer periphery of the plastic ring 21 includes a coupling section 211 having non-circular cross sections perpendicular to the longitudinal axis of the shaft 10c. The plastic magnet ring 22 is made of a combination of plastic material and magnetic powders and formed on the outer periphery of the plastic ring 21 by injection molding, with the inner periphery of the plastic magnet ring 22 engaged with the coupling section 211. Thus, the plastic magnet 20a is prevented from rotating relative to the shaft 10c and from disengaging from the shaft 10c. Besides, owing to the cost of the combination of plastic material and magnetic powders being much lower than that of a whole magnet, the plastic magnet ring 22 made of said combination costs less than a conventional magnet,

In use, the rotor 1, 2, 3, 4 according to the preferred teachings of the present invention is mounted inside a stator that can be mounted inside a fan housing and that can be operated to drive the rotor 1, 2, 3, 4 to rotate, forming an inner-rotor type motor. During rotation, since the inner periphery of the plastic magnet 20, 20a is securely engaged with the positioning portion 11, 12, 13, 14, disengagement of the plastic magnet 20, 20a from the shaft 10, 10a, 10b, 10c is prevented. Furthermore, rotation of the plastic magnet 20, 20a relative to the shaft 10, 10a, 10b, 10c is avoided, for the plastic magnet 20, 20a is securely fixed on the shaft 10, 10a, 10b, 10c. As a result, the product quality of the inner-rotor type motor is effectively enhanced.

According to the above, by providing a plastic magnet 20, 20a made of a combination of plastic material and magnetic powders and formed on the outer periphery of the shaft 10, 10a, 10b, 10c by injection molding, and by providing a positioning portion 11, 12, 13, 14 having non-circular cross sections, a secure coupling effect is obtained between the plastic magnet 20, 20a and the shaft 10, 10a, 10b, 10c while reducing the overall structural complexity and effectively enhancing the overall assembling convenience.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A rotor for a motor, comprising:
a shaft including an outer periphery having a positioning portion, with the positioning portion having non-circular cross sections perpendicular to a longitudinal axis of the shaft, with the positioning portion of the outer periphery of the shaft including at least one recess having a flat bottom face, with the at least one recess further having two flat walls formed at axially opposite ends of the flat bottom face, with the two flat walls being spaced and parallel and substantially perpendicular to the flat bottom face; and
a plastic magnet formed on the outer periphery of the shaft by injection molding, with the plastic magnet including an inner periphery engaged with the positioning portion.

2. The rotor for a motor as claimed in claim 1, with the positioning portion of the outer periphery of the shaft including a plurality of grooves each extending in a direction parallel to and spaced from the longitudinal axis of the shaft.

3. (canceled)

4. The rotor for a motor as claimed in claim 1, with the flat bottom face having a spacing to the longitudinal axis smaller than the outer periphery of the shaft.

5. The rotor for a motor as claimed in claim 1, with the plastic magnet including a plastic ring mounted around the outer periphery of the shaft, with the plastic ring including an inner periphery engaged with the positioning portion, with the plastic magnet further including a plastic magnet ring mounted around the plastic ring, and with the plastic magnet including an inner periphery engaged with an outer periphery of the plastic ring.

6. The rotor for a motor as claimed in claim 5, with the outer periphery of the plastic ring including a coupling section having non-circular cross sections perpendicular to the longitudinal axis of the shaft, and with the inner periphery of the plastic magnet ring engaged with the coupling section.
